(19) United States
(12) Patent Application Publication
(10) Pub. No.: US 2019/0384991 A1
(43) Pub. Date: Dec. 19, 2019

(54) METHOD AND APPARATUS OF IDENTIFYING BELONGING OF USER BASED ON IMAGE INFORMATION

(71) Applicant: LG ELECTRONICS INC., Seoul (KR)

(72) Inventors: Jungyong Lee, Seoul (KR); Gyeonghun Ro, Seoul (KR); Jungkyun Jung, Seoul (KR)

(73) Assignee: LG ELECTRONICS INC., Seoul (KR)

(21) Appl. No.: 16/554,411

(22) Filed: Aug. 28, 2019

(30) Foreign Application Priority Data
Jul. 25, 2019 (KR) 10-2019-0090245

(51) Int. Cl. G06K 9/00; G06K 9/46

(52) U.S. Cl. CPC G06K 9/00771; G06K 9/00832; G06K 9/4604

(57) ABSTRACT

At least one of an autonomous vehicle, a user terminal, and a server of the present disclosure may be connected to an artificial intelligence module, a drone (Unmanned Aerial Vehicle, UAV), a robot, an augmented reality (AR) device, a virtual reality (VR) device, a device related to 5G service, and so on. A method of providing information from an operating apparatus according to an embodiment of the present disclosure comprises: acquiring a first image information on a specific space; identifying a user based on the acquired first image information; identifying an item based on the acquired first image information; identifying a region corresponding to the user and a region corresponding to the item based on the acquired first image information; and determining whether the item is a belonging of the user based on the identified region corresponding to the user and the identified region corresponding to the item. According to embodiments of the present disclosure, the likelihood of users losing their belongings can be reduced by identifying the user and the belongings of the user based on image information and providing related information to the user.

### CROSS-REFERENCE TO RELATED APPLICATION

This application is based on and claims priority under 35 U.S.C. § 119(a) to Korean Patent Application No. 10-2019-0090245, which was filed on Jul. 25, 2019, in the Korean Intellectual Property Office, the disclosure of which is incorporated herein in its entirety by reference.

### BACKGROUND

### 1. Field

Embodiments of the present disclosure relate to a method and apparatus of identifying belongings of a user based on image information and providing information thereon to the user. More specifically, embodiments of the present disclosure relate to a method and apparatus in which belongings of a user are identified by analyzing image information and the user is provided with information on the belongings by various means.

### 2. Description of the Related Art

When a user boards a public transport, the user may board with belongings. At this time, it is possible for the user to drop belongings on the public transport, and there is a risk of loss. This risk of loss can frequently occur not only in public transport used by many users such as buses and subways but also in public transport used by a few users such as taxis and shared vehicles. Thus, there is a need for a method and apparatus for recognizing lost items and providing the user with related information.

### SUMMARY

Embodiments of the present disclosure are proposed to address the above-described problem, and an object of the present disclosure is to provide a method and apparatus for identifying a user and belongings based on image information in a vehicle and delivering related information to the user. More specifically, the object is to provide a method and apparatus for identifying user information, identifying belonging information corresponding to the user, continually collecting images in the vehicle based on the identified user and belonging information, and delivering related information if the user gets off with the belonging left in the vehicle. In addition, according to an embodiment of the present disclosure, it is another object to provide a method and apparatus for identifying a user and an item and determining whether the item is a belonging of a specific user.

In accordance with an embodiment of the present disclosure, a method of providing information from an operating apparatus comprises acquiring a first image information on a specific space, identifying a user based on the acquired first image information, identifying an item based on the acquired first image information, identifying a region corresponding to the user and a region corresponding to the item based on the acquired first image information; and determining whether the item is a belonging of the user based on the identified region corresponding to the user and the identified region corresponding to the item.

In accordance with another embodiment of the present disclosure, the first image information is acquired when the specific space is located at a location corresponding to specific location information set by the user.

In accordance with another embodiment of the present disclosure, the first image information is acquired based on at least one of a location of the specific space, a moving speed corresponding to the specific space, and whether the door is open or closed in the specific space.

In accordance with another embodiment of the present disclosure, the method further comprises providing the user with information on the item using a first method and discontinuing provision of information on the item when the user sets to discontinue provision of the information on the item.

An operating apparatus in accordance with another embodiment of the present disclosure comprises a communication unit configured to receive information; and a controller configured to control the communication unit, acquire a first image information on a specific space, identify a user based on the acquired first image information, identify an item based on the acquired first image information, identify a region corresponding to the user and a region corresponding to the item based on the acquired first image information, and determine whether the item is a belonging of the user based on the identified region corresponding to the user and the identified region corresponding to the item.

A non-volatile storage medium in accordance with yet another embodiment of the present disclosure stores an instruction for executing a method comprising acquiring a first image information on a specific space, identifying a user based on the acquired first image information, identifying an item based on the acquired first image information, identifying a region corresponding to the user and a region corresponding to the item based on the acquired first image information; and determining whether the item is a belonging of the user based on the identified region corresponding to the user and the identified region corresponding to the item.

According to embodiments of the present disclosure, it is possible to reduce the possibility that a user loses a belonging by identifying the user and the belonging of the user based on image information and providing the user with related information. In addition, according to embodiments of the present disclosure, a specific user can effectively receive information about a belonging by identifying the user, identifying the item inside a vehicle, determining to which user the item belongs, and providing the user with related information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device according to an embodiment of the present disclosure;

FIG. 2 illustrates an AI server according to an embodiment of the present disclosure;

FIG. 3 illustrates an AI system according to an embodiment of the present disclosure;

FIG. 4 is a view for explaining a method of identifying a user and a belonging according to an embodiment of the present disclosure;

FIGS. 5A and 5B are views for explaining a method of identifying a passenger in an image according to an embodiment of the present disclosure;

FIG. 6 is a view for explaining a method of determining whether it is a belonging to a user in accordance with a degree of overlapping of regions of interest according to an embodiment of the present disclosure;

FIGS. 7A and 7B are views for explaining a method of matching a user with a belonging according to an embodiment of the present disclosure;

FIG. 8 is a view for explaining a method of checking and managing belonging information of a passenger according to an embodiment of the present disclosure;

FIG. 9 is a view for explaining a method of providing information regarding the case in which a belonging is left in a vehicle when a passenger gets off the vehicle according to an embodiment of the present disclosure;

FIGS. 10A and 10B are views for explaining a method of identifying a belonging when a passenger left the belonging according to an embodiment of the present disclosure;

FIG. 11 is a view for explaining a method of transferring information on a user and a belonging via communication between an operating apparatus in a vehicle, a neighboring vehicle and a communication server according to an embodiment of the present disclosure;

FIG. 12 is a view for explaining a service that can be provided according to an embodiment of the present disclosure;

FIG. 13 is a view for explaining a method of managing user information according to an embodiment of the present disclosure;

FIG. 14 is a view for explaining a service providing method of an operating apparatus according to an embodiment of the present disclosure; and

FIG. 15 is a view for explaining an operating apparatus according to an embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task. In an embodiment of the present disclosure, the artificial intelligence may identify a user and an item through an analysis of an image in a vehicle and determine to which user the item belongs based on a relationship between the user and the item. Thereafter, information on the user and the belonging may be acquired from the image information additionally received at least one more time through the belonging list for each user. When the user leaves a belonging inside the vehicle, the user may be provided with related information by acquiring such information.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

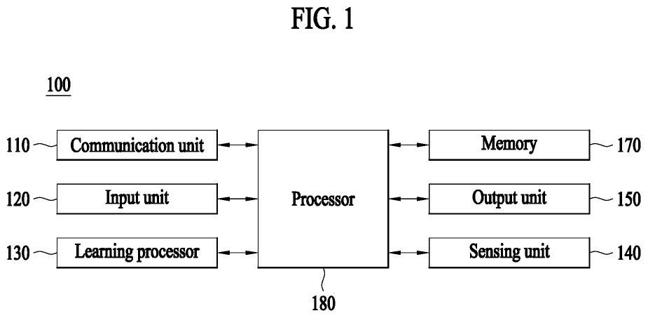

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle. In the embodiment, the AI device may be included in an operating apparatus which analyze an image and provide a user with information.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device. In the embodiment, at least one of a user and an item may be determined by image analysis in a vehicle.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

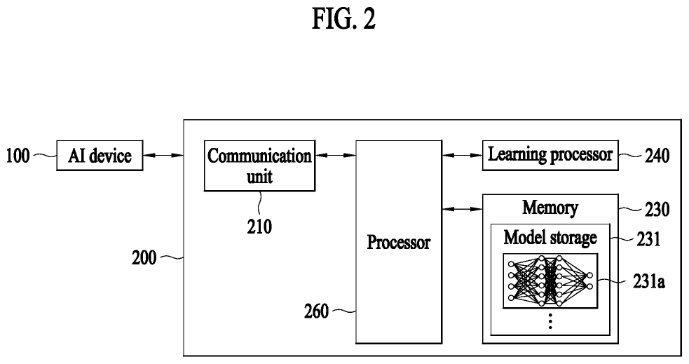

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

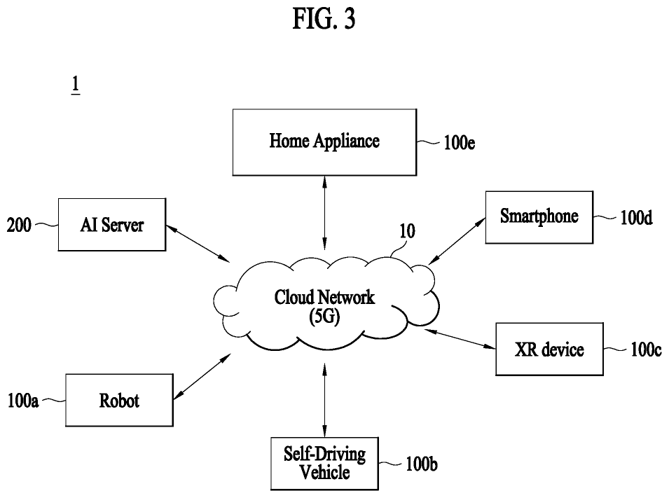

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to a region outside the field of vision or a region located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

An operating apparatus described in embodiments may perform communication with a cloud server using a communication service. More specifically, each of operating apparatuses of a plurality of vehicles may operate in conjunction with the cloud server using a 5G communication service, transmit identified information to the cloud server, and receive information transmitted to the cloud server through the operating apparatus of another vehicle from the cloud server. Meanwhile, in an embodiment, the cloud server may further receive information from an operating apparatus other than the one included the vehicle. For example, information may be transmitted and received while communicating with a user's home IoT server. As such, the cloud server may exchange information with various types of operating apparatuses. In addition, in the embodiment, it is apparent that the operating apparatus included in the vehicle may exchange information with the operating apparatus of another vehicle through inter-vehicle communication.

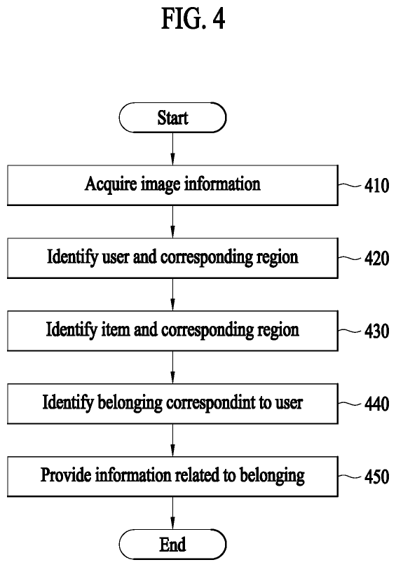

FIG. 4 is a view for explaining a method of identifying a user and a belonging according to an embodiment of the present disclosure.

Referring to FIG. 4, disclosed is a method which acquires image information, identifies a user and an item in the image based on the acquired image information, determines to which user the identified item corresponds, and provide the user with related information according to an embodiment of the present disclosure.

In step 410, an operating apparatus may acquire image information. In the embodiment, the image information may be image information of a region where a user and an item are to be analyzed to check the user's belonging, and, image information inside a vehicle may be acquired, for example. In the embodiment, the image information may be acquired from one or more cameras. When the image information is acquired from a plurality of cameras, the operating apparatus can acquire the image information after performing an operation of image processing for processing image to correspond to the space inside the vehicle. The image processed to correspond to the space inside the vehicle may include an image processed to compensate a blind spot of one camera with image information of other camera through images acquired from the plurality of cameras. By acquiring image information through the plurality of cameras, it is possible to more accurately grasp information inside the vehicle.

In the embodiment, image information may be acquired from a video source that is continually photographed. According to an embodiment, the operating apparatus may acquire image information from the video source at regular intervals. In addition, the operating apparatus may acquire image information from the video source when it meets a certain condition. More specifically, the operating apparatus may be controlled to acquire the image information when a user performs a payment after the user boards a public transport. As such, by acquiring the image information under a certain condition, user information may be identified by associating the corresponding condition with the user identified in the image information based on the information related to the condition. More specifically, by acquiring the image information when the user performs a payment for the transportation, the user information identified in the image is matched with the payment information and information related to the belonging is provided for the user based on the matched information.

In step 420, the operating apparatus may identify at least one of a user and a region corresponding to the user in the acquired image information. Identifying a user in such an image may be performed through an algorithm determined through deep learning, but is not limited thereto. On the image, a region where the user is located and the region corresponding to that user may be determined. The region corresponding to the user may include a predetermined portion around the region where the user is located, and it is possible to determine that the item located in that region is a belonging of the user based on that region. In the embodiment, the order of determining the user and the region corresponding to the user is not fixed and may be variously performed according to an algorithm. According to an embodiment, the region corresponding to the user may be in the form of a rectangle surrounding the identified user.

Further, in the embodiment, the operating apparatus may additionally acquire user information based on information other than the image information. For example, the user information may be identified based on information in which the user performs a payment to transportation, and such information can be utilized with the user information identified from the image information to provide the user with information on the belonging.

In step 430, the operating apparatus may identify at least one of an item and a region corresponding to the item in the acquired image information. In the embodiment, identifying the item may include identifying feature information including a type of the item based on the image information. The operating apparatus may identify a certain item, a type of the identified item, and a region corresponding to the item through image analysis. The region corresponding to the item may include a predetermined portion around the item, and the operating apparatus may determine to what extent of the region is included in the region corresponding to the item based on at least one of a type, a size, and a moving speed of the item.

In step 440, the operating apparatus may determine whether the item is a belonging of a certain user based on the identified user and item information. In the embodiment, the operating apparatus may determine whether the item is a belonging of a certain user based on an area where the region corresponding to the user and the region corresponding to the item overlap with each other. More specifically, the item may be determined to be the user's belonging if a degree of overlapping of the region corresponding to the user and the region corresponding to the item is equal to or more than a predetermined value. The degree of overlapping to determine that the item belongs to the user may depend on types of item. More specifically, an item that is usually close to the body is determined as a belonging when the degree of overlapping is relatively higher. Otherwise it may be determined as a belonging even if the degree of overlapping is not that high, but it is not limited thereto.

In addition, when a region corresponding to a specific item has a larger overlapping area with a region corresponding to the second user than that with a region corresponding to the first user, the item may be determined as a belonging to the second user. In the embodiment, the determination condition for the degree of overlapping may be a preset condition, and the condition may be updated depending embodiments. More specifically, the condition may be undated based on at least one of a determination of the operating apparatus and an input of an additional algorithm. Further, in the embodiment, the determination condition may be based on the type of the item, the number of the users identified on the image information and so on.

In addition, the item may be determined to be the user's item if the user and the item move together. According to an embodiment, if the identified user and the identified item move together for a predetermined time, the item may be determined to be the user's belonging. More specifically, a degree of overlapping of the region corresponding to the user and the region corresponding to the item in the image information acquired additionally is equal to or more than a determination condition, then the item may be determined to be the user's belonging. In the embodiment, the determination condition may be the same as or different from the determination condition for determining based on one image information. Further, depending on embodiments, the condition for determining the degree of overlapping in the plurality of image information may be lower than the condition for determining the degree of overlapping on a single image. In addition, in the embodiment, when the degrees of overlapping between a specific item and a plurality of users are similar, the operating apparatus may recognize the item as the belonging of the user who is most overlapped for the longest time of the entire monitoring time. Further, when a belonging is transferred from one user to another user by passing the belonging between users, the degree of overlapping with the transferred user is determined and the item is determined as the belonging of another user to whom it has been transferred if the degree of overlapping over a certain range is maintained for a certain time.

In the embodiment, the operating apparatus may consider the result of the determination based on the image information acquired near the location where the user first boarded, prior to the result of the determination based on the other image information when determining the belonging.

In step 450, the operating apparatus may provide the user with information related to the belonging based on the identified information. According to an embodiment, the operating apparatus may manage belongings list for each identified user and may provide the information related to the belonging for the user if the user gets off the vehicle with the belonging left inside the vehicle. Further, according to an embodiment, if the item in which the user left inside the vehicle when the user gets off the vehicle is a hazardous item, the operating apparatus may provide the vehicle manager with the information related to the item. In the embodiment, if it is related for the user to get off and the user and the belonging are spaced apart to satisfy a certain condition, information related to the item may be provided for the user.

In the embodiment, the operating apparatus may predict whether the user gets off and check if the user gets off with the belonging based on the acquired image.

As an example, when the user sets a getting off point through the user terminal, etc., it may be predicted that the user would get off based on the getting off point. For example, when the vehicle approaches the getting off point which has been set within a certain distance or it is expected to arrive within a certain time, it may be determined that the user gets off. In this way, if the operating apparatus predicts that the user would get off, it is possible to check whether the user drops the belonging based on the image collected at the corresponding time.

As another example, the operating apparatus may predict that the user would get off based on at least one of the speed of the vehicle, the position of the vehicle, and the door state of the vehicle.

For example, if the speed of the vehicle decreases below the preset speed, it can be expected that the user is more likely to get off. Further, if the vehicle is stopped, it can be expected that the user is likely to get off. Also, if the location where the vehicle is stopped is suitable for the user to get off, it can be expected that the user is likely to get off. In the embodiment, the location suitable for the user to get off may be a location where parking or stopping is allowed, and the operating apparatus may detect whether the vehicle is located at a location suitable for the user to get off based on information acquired from the sensor of the vehicle. In the embodiment, even if the speed of the vehicle is less than or equal to a preset value, when the vehicle is located at a location that is not suitable for the user to get off, the operating apparatus may determine that the user does not get off.

In addition, the operating apparatus may expect that the user would get off if the door of the vehicle is open. Also, the user may be expected to get off if the user is within a certain distance from the door when the door is open.

In the embodiment, a method of providing user with information may include at least one of a method of providing information related to belongings to a user's terminal based on the acquired user information, a method of providing information related to the belongings through a display unit or a speaker unit of a vehicle, and a method in which the user transmits information related to the belongings to a neighboring vehicle through V2X communication. In addition, in the embodiment, the operating apparatus may repeatedly provide the user with information related to the belongings. If the user fails to check the information related to the belongings, the operating apparatus may repeatedly provide the user with the information related to the belongings. Meanwhile, if the user sets that there is no need to provide information about the belongings, the operating apparatus may not provide such information. As an example, when the user has set that there is no need to provide information any more through one of the voices, gestures, and information input through the user terminal, the operating apparatus may no longer provide information for the user. In one example, the operating apparatus may continually provide the user with information related to the belongings, but the embodiment may be implemented in such a manner that such information is not output to the user terminal.

In the embodiment, regions corresponding to the user and the item can be referred as regions of interest (ROIs) and the operating apparatus may perform user identification, user tracking and belonging identification based on at least one of the ROIs of the user and the item.

In this way, when the user drops the belonging inside the vehicle, the user may be prevented from losing the belonging by providing the related information to the user, and even if the user drops the belonging, the related information is effectively provided to the user so that the user can easily recover the belonging.

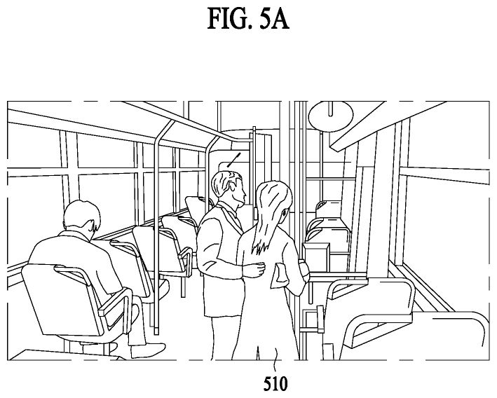

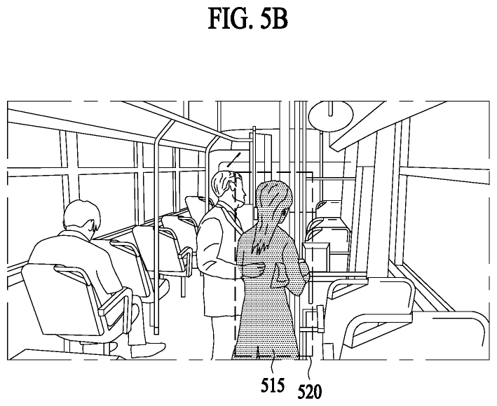

FIGS. 5A and 5B are views for explaining a method of identifying a passenger in an image according to an embodiment of the present disclosure.

Referring to FIGS. 5A and 5B, a method in which an operating apparatus identifies a passenger and a corresponding region based on acquired image information inside a vehicle.

The operating apparatus may identify a first passenger 510 through image analysis in the acquired image information of FIG. 5A. In the embodiment, identifying of the first passenger may be performed based on an algorithm generated through deep learning, machine learning, etc., and one or more passengers may be identified in the acquired image information depending on embodiments.

As shown in FIG. 5B, a corresponding region 520 for the identified first passenger 515 may be identified. In the embodiment, corresponding region 520 may include a predetermined portion around the first passenger 515, and, for the item identified in corresponding region 520, the operating apparatus may determine the item as a belonging of the first passenger 515 based on a degree of overlapping with corresponding region 520. In the embodiment, the size of corresponding region 520 varies depending on the type of transportation, and the size of corresponding region 520 can be reduced as the passengers are located adjacent to each other with the large number of passengers on board. As such, the operating apparatus may adaptively change the size of region 520 corresponding to the passenger based on the situation inside the vehicle.

In the embodiment, the operating apparatus may track and manage the first passenger 515 in the image information obtained thereafter once the first passenger 515 is identified. If the first passenger 515 moved in the image information acquired subsequently, corresponding region 520 is identified at the moved location. If there is identified belonging information for the first passenger 515, it can be identified as well. Further, in the embodiment, once it is identified as a belonging of the passenger, the operating apparatus may identify the belonging as it belongs to that passenger even if the passenger and the belonging are spaced apart.

Also, in the embodiment, the operating apparatus may receive information on the passenger and the belonging corresponding to the passenger when the passenger boards the vehicle. More specifically, the operating apparatus may receive the information on the passenger and the belonging of the passenger and check whether the passenger's belonging is present on the image acquired based on the received information. Such passenger information and corresponding belonging information may be input by the passenger or provided to the operating apparatus from a server related to the passenger. In addition, the belonging information may include at least one of the type, shape, color, and size of the belonging, and may include image information on the belonging according to an embodiment. When the passenger boards, the operating apparatus may determine whether the belonging is detected on the acquired image based on the information registered as the belonging of that passenger. In the embodiment, registration of the belonging may be performed through a separate server. For example, the separate server may include a home IoT server owned by a user. In addition, according to an embodiment, a specific item may be registered as a user's belongings through the terminal of the passenger.

This matching makes it possible to identify the belonging with higher accuracy. More specifically, the belongings may be detected from an image acquired inside the vehicle based on the image information of the belonging registered in advance. For example, an operation of comparing the image information of the belonging registered in advance with the image information acquired in the vehicle may be performed.

According to an embodiment, if the registered belonging is not detected in the acquired image information, the operating apparatus may provide the user with the related information. In the embodiment, the operating apparatus may provide the user with the information of the registered belonging together with information that the belonging is not detected. As an example, when the registered belonging is located in a passenger's pocket or bag, the operating apparatus may not detect the registered belonging on the acquired image, and thus may provide the user with the belonging information and related information. When providing such information to the user, the operating apparatus may provide an alarm to the user in different ways depending on the size of the belonging. As an example, if a belonging of a size that can be put in a pocket or a bag is not detected in the image inside the vehicle, the operating apparatus may provide the user with information for identifying the situation. In an embodiment, the operating apparatus notifies the passenger when the passenger has boarded without the registered belonging so that the passenger can perform related actions.

In the embodiment, if there is information on a pre-registered belonging, the operating apparatus may identify it as the user's belonging even if the passenger and the belonging are not overlapping with each other in the image acquired inside the vehicle.

Further, according to an embodiment, if the second passenger carries the item which is identified as a belonging of the first passenger, the operating apparatus may provide information about the same to at least one of the first passenger and the second passenger. More specifically, if the second passenger carries an item that is identified as a belonging of the first passenger before the second passenger boards, the operating apparatus may inform the first passenger of the information about it and the second passenger may also be informed that it belongs to the first passenger. For example, when the second passenger gets off with the belonging of the first passenger, the operating apparatus may provide related information to the first passenger and may provide the second passenger with information suggesting leaving that belonging. Further, when the belonging of the first passenger is transferred to the second passenger through overlapping with the second passenger, the operating apparatus performs an operation of storing the related information, and subsequently providing the first passenger with the information about the second passenger as information related to the lost item.

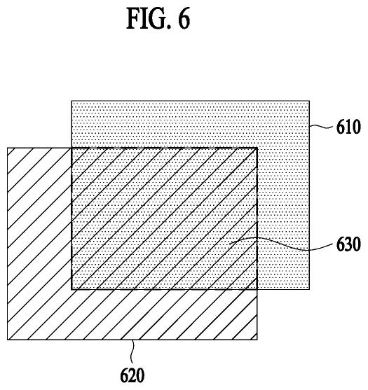

FIG. 6 is a view for explaining a method of determining whether it is a belonging to a user in accordance with a degree of overlapping of regions of interest according to an embodiment of the present disclosure.

Referring to FIG. 6, two overlapping ROIs are shown. In the embodiment, a first ROI 610, a second ROI 620, and an overlapping region 630 are shown, in which the first ROI 610 corresponds to a user and the second ROI 620 corresponds to an item.

In the embodiment, it may be determined whether an item is a user's belonging based on a ratio of overlapping region 630. More specifically, whether the item corresponding to second ROI 620 is the belonging of the user corresponding to the first ROI 610 based on the ratio of the size of the region obtained by subtracting overlapping region 630 from the sum of the first ROI 610 and the second ROI 620 and the size of overlapping region 630.

Ratio=(overlapping region)/(first ROI+second ROI−overlapping region) [Equation 1]

For example, if the ratio of the overlapping region is 0.7 or more, the corresponding item may be identified as the user's belonging. According to an embodiment, the ratio of the overlapping region determined as belonging may vary according to the type of the item corresponding to the second ROI.

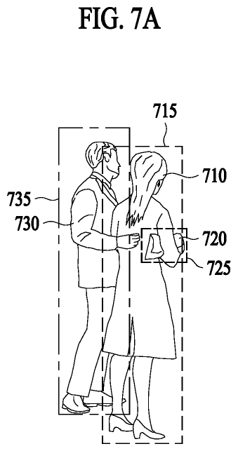

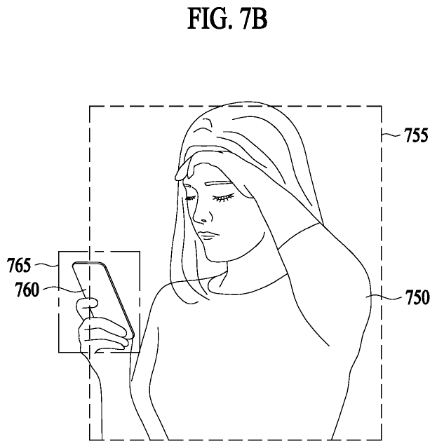

FIGS. 7A and 7B are views for explaining a method of matching a user with a belonging according to an embodiment of the present disclosure.

Referring to FIGS. 7A and 7B, disclosed are diagrams of identifying a user and an item and of matching which user's belonging the item is.

Referring to FIG. 7A, a first user 710, a first corresponding region 715, a second user 730, a second corresponding region 735, a first item 720, and a corresponding region 725 thereof are shown. Identifying these users, item and respective corresponding regions may be performed by the operating apparatus, using a method described in the previous embodiment. At this time, the operating apparatus may identify to which user the first item 720 belongs. According to the embodiment, the operating apparatus may identify overlapping regions of region 725 corresponding to the first item and region 715 corresponding to the first user or region 735 corresponding to the second user. Since the degree of overlapping of region 715 corresponding to the first user and region 725 corresponding to the first item is larger in the embodiment, the operating apparatus may identify that the first item 720 as a belonging of the first user 710.

According to an embodiment, if the degrees of overlapping of the item and multiple users are similar, determination of the belonging is deferred. Then, additional image information is received to identify to which user the specific item belongs. For example, if the difference between the overlapping degrees with the neighboring users does not differ by more than 5-15%, the operating apparatus may additionally acquire image information to identify to which user the specific item belongs.

Referring to FIG. 7B, a third user 750, a corresponding region 755 thereof, a second item 760, and a corresponding region 765 thereof are identified. In the embodiment, the operating apparatus may identify the second item 760 as a belonging of the third user 750 if the second item 760 is continuously identified around the third user 750 in multiple image information. Further, the operating apparatus may also consider the degree of overlapping of the ROIs of the second item 760 and the third user 750 to check if it is a belonging of that user.

Also, in the embodiment, if the belonging of the user is a device in which the operating apparatus can provide the user with information, an alarm can be provided through a separate method. In this way, when a passenger leaves a device inside the vehicle that can receive alarms related to the belonging, such information can be provided to the user through a separate alarm. In the embodiment, the separate alarm may include providing an alarm to the passenger through a stronger output than a conventional alarm, and may include providing a separate alarm to the passenger through an output device inside the vehicle.

In the embodiment, a method in which the operating apparatus identify the user and the item based on the acquired image information, identify to which user the specific item belongs, and increase the accuracy of the identification is disclosed.

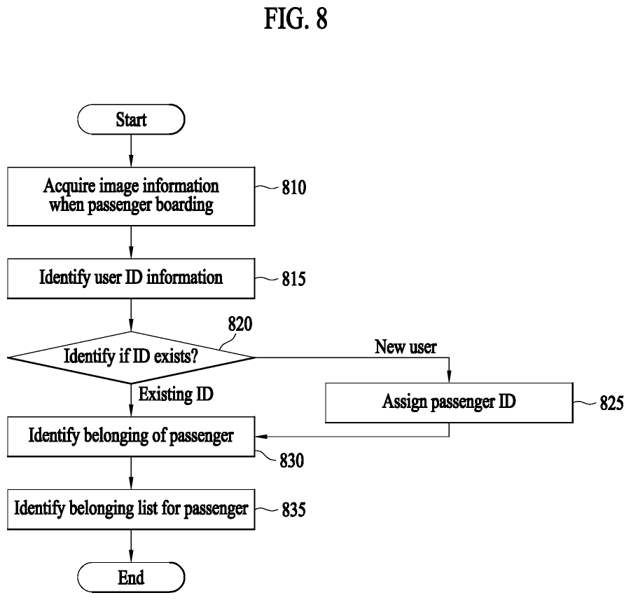

FIG. 8 is a view for explaining a method of checking and managing belonging information of a passenger according to an embodiment of the present disclosure.

Referring to FIG. 8, the operating apparatus identifies a user based on acquired image information, assigns identification information (ID) to the user to track the user in the same way in the image information which is additionally acquired even when the user moves.

In step 810, the operating apparatus may acquire image information when a passenger boards. In an embodiment, this may be implemented by acquiring image information when a passenger boards the vehicle among image information continuously photographed. More specifically, when the user boards a vehicle such as a bus and performs an operation for payment, image information may be acquired. Further, in the embodiment, the operating apparatus may obtain image information of a time point corresponding to tagging the NFC card of the user to the terminal of the bus. In the embodiment, the operating apparatus may identify the user based on at least one of the acquired image information and the user's tag information. According to an embodiment, the user may be identified based on face recognition information of the user to be identified on the image information, or the user may be identified based on information tagged by the user on the bus terminal.

In step 815, the operating apparatus may check user ID information based on the identified user information. More specifically, the user ID can be information for identifying the user in the whole system, or information for identifying the user in the vehicle according to an embodiment. In the embodiment, the operating apparatus may check the ID information based on the information in which the user tagged on the bus terminal in the previous step, or based on face recognition information.

In step 820, the operating apparatus may determine whether the checked ID information is an existing ID. More specifically, the operating apparatus may check whether ID information corresponding to a specific user is stored in the storage unit. In the embodiment, the ID information stored in the storage unit may comprise ID information assigned by the vehicle in which the user boards and ID information identified and assigned by another vehicle as well.

The operating apparatus may assign a new passenger ID to a recognized user in step 825, if the user is a new user. The ID information assigned as described above may be stored in a storage unit associated with the operating apparatus and may be transmitted to another vehicle or a separate server through inter-vehicle communication or a communication with the separate server. By sharing the assigned ID with other vehicles or servers in this way, the stored ID can be assigned to continuously track the user in another vehicle when a corresponding user is also identified by another vehicle later.

In step 830, the operating apparatus may identify one or more items based on the image information inside the vehicle, and determine whether the identified item is a belonging to a specific user. The operating apparatus may use the method of determining a belonging described in the previous embodiment.

In step 835, the operating apparatus may manage corresponding belonging information for the identified passenger. More specifically, the corresponding belonging information for a specific passenger ID can be checked and stored, and the passenger and the belonging information can be continuously checked from the acquired plurality of image information to provide the passenger with related information when the passenger leaves the belonging in the vehicle.

In the embodiment, the operating apparatus identifies the user based on the acquired image information, assigns the user the ID to track and identify in the same way on the image information additionally acquired even if the user moves.

Further, by assigning an ID to a specific user and managing the belonging information by the passenger ID, not only the information related to the belonging can be provided to the passenger inside the vehicle but also the passenger can be associated through the same ID even when the passenger is in another vehicle. As a result, information related to the belonging can be continuously provided for the passenger transferred to other vehicles through inter-vehicle communication or communication through a separate communication device.

When the user transfers from the first vehicle to the second vehicle after the information on the user and the belonging corresponding to the user is generated according to the embodiment, at least one of the operating apparatus of the first vehicle and the operating apparatus of the second vehicle checks the information on the user and the corresponding belonging corresponding to at least one time point of when the user gets off the first vehicle and when the user boards the second vehicle, and whether the user and the belonging correspond to each other based on the image acquired inside vehicle.

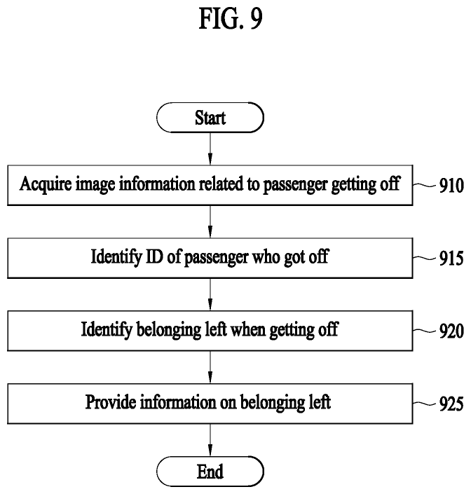

FIG. 9 is a view for explaining a method of providing information regarding the case where a belonging is left in a vehicle when a passenger gets off the vehicle according to an embodiment of the present disclosure.

Referring to FIG. 9, the operating apparatus may manage passenger-related information, determine whether a belonging is left when the passenger gets off based on the acquired image information, and provide the passenger with related information.

In step 910, the operating apparatus may acquire image information related to the passenger who is getting off. For example, if it is identified that there is no passenger in the vehicle's entire image information among passengers who are assigned IDs by the vehicle, the operating apparatus may determine that the passenger has gotten off. In addition, in the embodiment, when it is identified that the passenger got off from the image information related to the exit related to getting off, the operating apparatus may determine that the passenger got off.

In step 915, the operating apparatus may check ID information of the passenger who got off. For example, the ID information of the passenger who got off based on the ID information which is previously assigned based on the image information. Further, in the embodiment, the operating apparatus may determine whether the passenger got off based on the passenger-related information tagged on the vehicle when the passenger was getting off without help of the image information, and check the ID information of the passenger who got off using the tagged information and the image identification information together. When the passenger tags the passenger information related to getting off to the vehicle in the previous step, the image information corresponding thereto may be acquired, and it may be determined whether the passenger has gotten off based on the acquired image information. In addition, in the embodiment, when the information related to the passenger is input to the vehicle through a tag, etc., the operating apparatus may additionally acquire image information of a related location. According to an embodiment, it is possible to control to acquire image information of a related location more frequently.

In step 920, the operating apparatus may check belonging information corresponding to the passenger who got off and check whether there is a belonging left in the vehicle among the belongings based on image information inside the vehicle. For example, the operating apparatus may track and check the belonging which is identified to be a belonging of a specific passenger continuously and check whether the belonging is likely to remain in the vehicle in the case where the passenger gets off or performs an action related to getting off. When it is identified that the passenger gets off the vehicle by performing such an action before getting off the vehicle, it is possible to provide information related to the belonging to the passenger immediately.

In step 925, the operating apparatus may provide the passenger who is getting off with the belonging left in the vehicle with the information related to the belonging. For example, an output device installed in a vehicle may immediately provide the passenger with information related to the belonging. In addition, information related to the belonging may be provided to a neighboring vehicle or a terminal of the passenger through a communication device. Through this, the passenger can be immediately provided with the information related to the belonging at the time of getting off, or the information related to the belongings can be provided through the inter-vehicle communication and the information related to the belonging can be checked based on the received information on the terminal of the passenger via separate communication even when the passenger got off and boarded another vehicle. Further, in the embodiment, the operating apparatus may back up one of the information related to the passenger and the belonging if the passenger is provided with information related to the belonging, but the passenger still left the belonging. More specifically, the image information related to a customer acquired in the vehicle may be backed up, and provided to other nodes so that authentication may be performed through the information provided when the passenger recovers the lost item later.

In the embodiment, the operating apparatus may exchange information related to the user with the communication server corresponding to at least one time point of the passenger boarding, getting off, or transferring to another means of transportation. More specifically, the operating apparatus may provide user information or be provided with information related to the user via communication with a 5G server. Through such information exchange, user information may be commonly managed or authentication related to the user may be performed. In addition, in the embodiment, information related to the user may be stored in a cloud server.

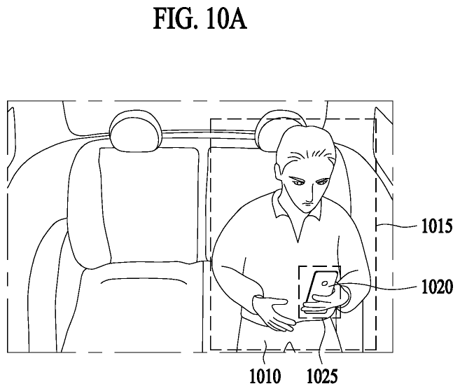

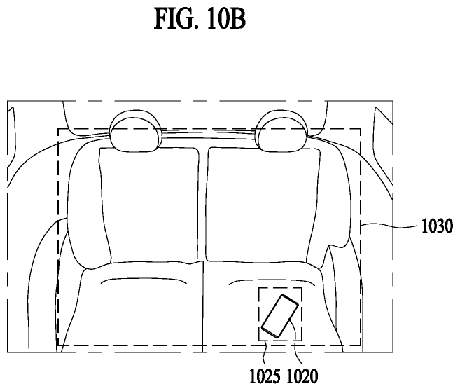

FIGS. 10A and 10B are views for explaining a method of identifying a belonging when a passenger left the belonging according to an embodiment of the present disclosure.

Referring to FIGS. 10A and 10B, a method in which the operating apparatus identifies a passenger and a belonging inside a vehicle and determines whether the passenger got off with the belonging left in the vehicle.

In the embodiment, the operating apparatus may acquire image information inside vehicle multiple times, identify the passenger and the item based on the acquired image information, and determines whether the item is a belonging of a specific user.

In the embodiment, the operating apparatus identifies a passenger 1010 and a region 1015 corresponding to the passenger and identifies an item 1020 and a region 1025 corresponding to the item in the image of FIG. 10A. In the embodiment, the item 1020 may be a mobile phone; however, it is apparent that the method of the embodiment can be performed in a similar manner for other items.

Based on the overlapping degree of region 1015 corresponding to the passenger and region 1025 corresponding to the item, it may be determined whether item 1020 is a belonging to the specific passenger 1010. In the embodiment, the two regions completely overlap, and the operating apparatus can identify item 1020 as a belonging of passenger 1010. If the two regions do not overlap completely or there are a plurality of passengers, the operating apparatus determines which passenger the item belongs to based on at least one of: which overlapping degree with the passengers is higher, the type of the item, and if the overlapping degree exceeds the preset degree as described in the previous embodiment. In the embodiment, when the operating apparatus determines whether item 1020 is a belonging of passenger 1010, it can be determined by tracking passenger 1010 and item 1020 in the image information acquired thereafter.

Referring to the image of FIG. 10B, the operating apparatus may identify that item 1020 is located in region 1030 and passenger 1010 has gotten off based on the acquired image information. As such, when the operating apparatus identify that the belonging has been left after passenger 1010 got off, passenger 1010 may be provided with information on item 1020. The information on item 1020 may be provided for passenger 1010 through an output device of the vehicle, communication with a neighboring vehicle, or communication with a separate communication device.

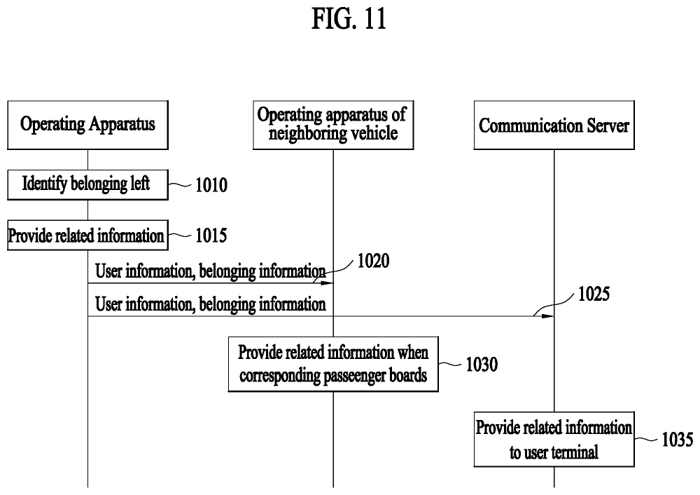

FIG. 11 is a view for explaining a method of transferring information on a user and a belonging via communication between an operating apparatus in a vehicle, a neighboring vehicle and a communication server according to an embodiment of the present disclosure.

Referring to FIG. 11, a method in which the operating apparatus provides the user with information related to the belonging of the user, and provides information by transferring to another node.

In step 1010, the operating apparatus may identify belonging information left in the vehicle. In the embodiment, the belonging left behind can be identified by the method described in the previous embodiment. For example, the operating apparatus may determine that the belonging is left in the vehicle if the user is located in a location related to getting off and the belonging of the user is spaced apart. Also, the operating apparatus may determine that the belonging is left in the vehicle when an item recognized as the belonging of the user is located in the vehicle after the user got off.

In step 1015, the operating apparatus may provide information related to the belonging left to the user corresponding to the belonging through an output device in the vehicle. For example, the information related to the belonging may be provided through a display in the vehicle, or the information related to the belonging may be provided through a sound output unit in the vehicle. Providing such information may also be performed by providing information on the belonging when the user's location, in which the operating apparatus has identified through the image information, is related to getting off and the user and the belongings of the user are spaced apart.

In steps 1020 and 1025, the operating apparatus may transmit at least one of information on the vehicle corresponding to the operating apparatus, the user information and the belonging information to at least one of an operating apparatus of a neighboring vehicle and a communication server if the user got off with the belonging left in the vehicle. In the embodiment, the operating apparatus may select a neighboring vehicle the user may board after getting off and provide the operating apparatus of the selected vehicle with at least one of the user information and the belonging information.

Further, the operating apparatus may transmit at least one of the user information and the belonging information to the communication server that can communicate with a terminal of the user based on the user information. For example, the communication server may be selected or information to be transmitted to the communication server may be determined based on the payment information of the user. In one example, the communication server may be a cellular communication server, but is not limited thereto. It may be another communication server capable of providing information to a user.

In step 1030, the operating apparatus of the neighboring vehicle may provide the information related to the belonging when the user boards as a passenger based on the information received in step 1020. In the embodiment, the operating apparatus of the neighboring vehicle may provide the information related to the belonging left based on at least one of received information via an output device of that vehicle.

In step 1035, the communication server may provide related information to the terminal of the user corresponding to the belonging left based on received information. In the embodiment, the communication server may identify information to communicate with the terminal of the user based on the received information. It may also provide the terminal of the user with at least one of the received information based on the identified information.

As such, the operating apparatus related to the vehicle provides the information related to the belonging left to the user through the output device inside the vehicle, or to the neighboring vehicle or the communication server to provide the user with the information related to the belonging left through a separate method, so that the user can effectively obtain information about the lost belonging.

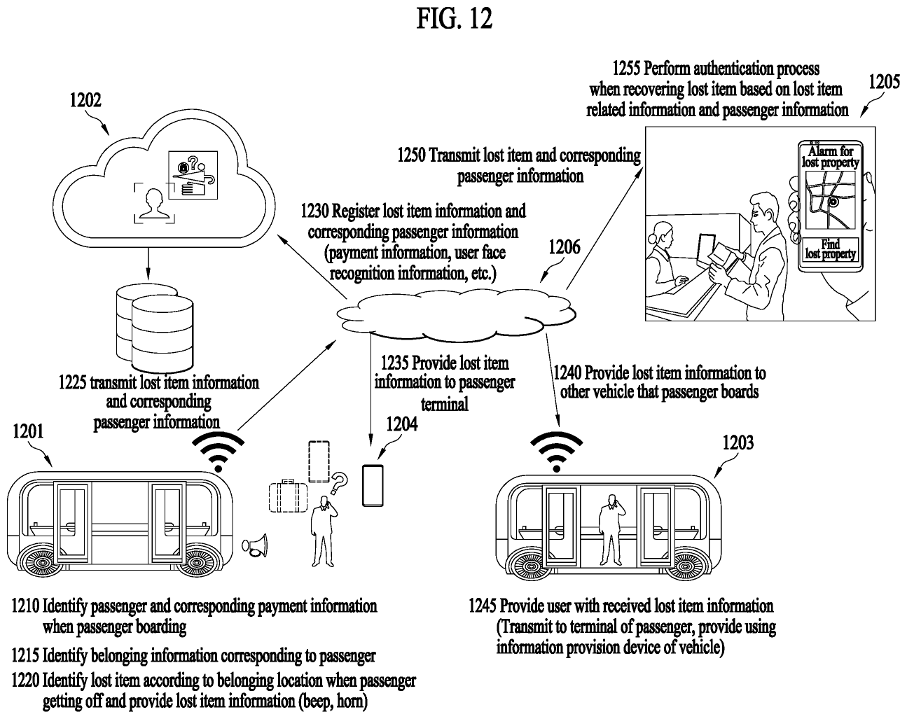

FIG. 12 is a view for explaining a service that can be provided according to an embodiment of the present disclosure.

Referring to FIG. 12, the operating apparatus installed in a vehicle 1201 checks information on passengers and belongings and provides checked information to other nodes via a cloud server 1206, so that a user can be provided with the belonging information by various methods.

First, in step 1210, when a passenger boards vehicle 1201, the operating apparatus may check information of the passenger. In addition, the operating apparatus may recognize the passenger through identification information of the passenger including payment information of the passenger and image information of the passenger. For example, the passenger information may include identification information of a payment card for boarding vehicle 1201.

In step 1215, the operating apparatus may identify belongings corresponding to the passenger using at least one of the methods described in the previous embodiments.

In step 1220, the operating apparatus may provide the passenger with information related to the belongings based on the state of the belongings when the passenger gets off. According to an embodiment, the operating apparatus may inform whether a passenger has a lost item according to the locations of the belongings, and the operating apparatus may provide the information related to the belongings through at least one of the output device of vehicle 1201 and the terminal of the passenger.

In step 1225, the operating apparatus may transmit information related to at least one of the passenger and the belongings to a cloud server 1206. Such information may be transmitted before or during performing steps 1210 to 1220, and may include at least one of the information checked and identified at each step. In an embodiment, the operating apparatus may transmit information related to the passenger and the lost item left by the passenger to the cloud.

In step 1230, cloud server 1206 may transmit at least one of the information related to the passenger and the belongings to an information server 1202. In an embodiment, cloud server 1206 may transmit the lost item and corresponding passenger information to information server 1202, and the passenger information may include at least one of the payment information and face recognition information of the passenger. The lost item information may include at least one of the image information related to the lost item, other passenger information related to the lost item, and identification information about the lost item.

In the embodiment, information server 1202 may store the received information, and may provide the requested information to another node when the corresponding information is requested from another node.

In step 1235, cloud server 1206 may provide the information related to the lost item to passenger terminal 1204. The lost item information may be provided corresponding to the getting off time of the passenger, and the lost item information can be provided even after the time of getting off if the lost item is found.

In step 1240, cloud server 1206 may provide at least one of the passenger and belonging related information when the passenger boards another vehicle 1203, Such information may be provided through cloud server 1206, but may also be provided through vehicle-to-vehicle communication as described in the embodiment.

In step 1245, another vehicle 1203 may provide the passenger with the received information. In the embodiment, the received information may be transmitted to the user terminal or provided to the passenger through an information providing apparatus of the vehicle.

In step 1250, cloud server 1206 may provide information related to the passenger and the belonging to a server related to the lost and found center. The information provided may include the user information and the lost belonging information. Cloud server 1206 provides passenger terminal 1204 with identification information for finding the lost item in advance, and the passenger can retrieve the lost item by providing the lost and found center with the information provided to terminal 1204 to pass the authentication process.

In step 1255, the passenger may retrieve the item stored in the lost and found center. In the embodiment, user authentication may be performed through at least one of the user face recognition information and information transmitted to the terminal, and the lost and found center may provide the lost item to the passenger according to the authentication result.

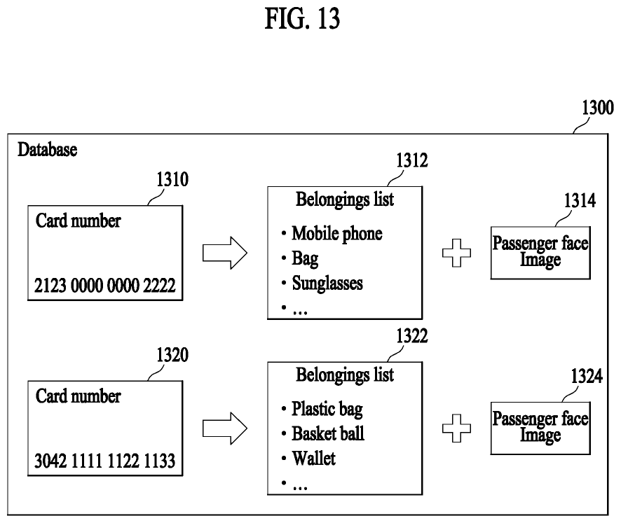

FIG. 13 is a view for explaining a method of managing user information according to an embodiment of the present disclosure.

Referring to FIG. 13, a data storage structure of a database 1300 is disclosed. In the embodiment, database 1300 may be located in a vehicle or a separate server outside the vehicle.

In the embodiment, card numbers 1310 and 1320 for payment for transportation may be stored as the identification information. For such card numbers, an operating apparatus of a vehicle may provide card information for a user to database 1300 if a passenger boards a vehicle and performs a payment via the card. In the embodiment, the card information may be used as information for identifying the user.

In the embodiment, the operating apparatus may store belongings lists 1312 and 1322 corresponding to the users in database 1300 based on at least one of information identified in the image of the inside of the vehicle and information preset by the user.

In the embodiment, the operating apparatus may store passenger face images 1314 and 1324 information corresponding to the card numbers in database 1300.

By storing information related to the passengers and the belongings in database 1300, the information can be effectively managed. If any item is lost, information corresponding to the lost item in the belongings list of database 1300 is checked and provided to the passenger. In addition, although not shown, it is obvious that additional information such as the contact information of the passenger may be stored together in the embodiment.

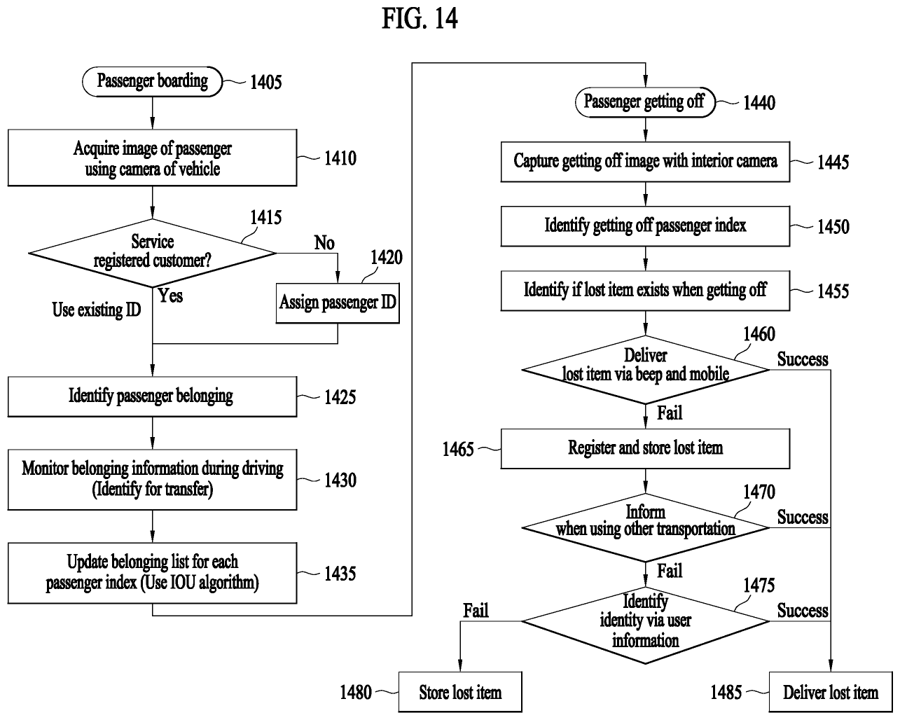

FIG. 14 is a view for explaining a service providing method of an operating apparatus according to an embodiment of the present disclosure.

In step 1405, a passenger may board a vehicle.

In step 1410, the operating apparatus may acquire image information related to the passenger using a camera in the vehicle. In the embodiment, the image information may include image information corresponding to the time point that the payment is made.

In step 1415, the operating apparatus may determine whether it is a registered passenger. If the passenger is not previously registered, the operating apparatus may assign an ID for identifying the passenger in step 1420. In the case of a previously registered passenger, the operating apparatus may identify the passenger using the existing ID information.

In step 1425, the operating apparatus may identify the belongings of the passenger based on at least one of the acquired image information and information previously registered by the passenger.

In step 1430, the operating apparatus may continuously monitor the belongings information while driving, and may monitor the situation as the belonging is transferred to another passenger.

In step 1435, the operating apparatus may update the belongings list for each passenger's identification information. In the embodiment, the operating apparatus may update the passenger's belongings information based on a region (IOU, intersection of union) where the specific item and the specific passenger overlap in the acquired image.

In step 1440, the operating apparatus may determine whether the passenger gets off. In the embodiment, it may be identified as getting off when the passenger performs an action related to getting off inside the vehicle.

In step 1445, the operating apparatus may acquire image information related to getting off using the indoor camera. For example, by taking an image of the passenger when getting off through the indoor camera, the passenger may be identified and personal belonging information may be identified based on the image.

In step 1450, the operating apparatus may check the identification information of the passenger who got off based on the acquired information.

In step 1455, the operating apparatus may determine whether there is any lost item left inside the vehicle upon getting off based on the identification information of the passenger who got off.

In step 1460, if there is a lost item, the operating apparatus may provide the user with information related to the lost item through an output device inside the vehicle and a user terminal.

Through this, if the lost item is recovered by successfully delivering the information to the user, the lost item may be delivered in step 1485.

If the lost item is not delivered, the operating apparatus may register the lost item information and store it in step 1465. In the embodiment, the lost item information may include storing passenger information and information related to lost item, and passing the information to another node.

If it is identified that the passenger who got off uses another transportation means in step 1470, at least one of the passenger information and the lost item information may be transmitted to the corresponding transportation means. If the passenger identifies the lost item, the operating apparatus may perform a procedure for delivering the lost item in step 1485.

If the lost item is not delivered by the above method, the lost item can be stored in a separate lost and found storage center. In the embodiment, the operating apparatus may transmit the passenger information and the lost item information to a server associated with the center for effective storage of lost items, and in step 1475, the lost and found center may verify the user identity based on the received information and deliver the lost item. If the user identity is not verified, the lost item may be stored as shown in step 1480, and the server related to the lost and found center may store information for storage together.

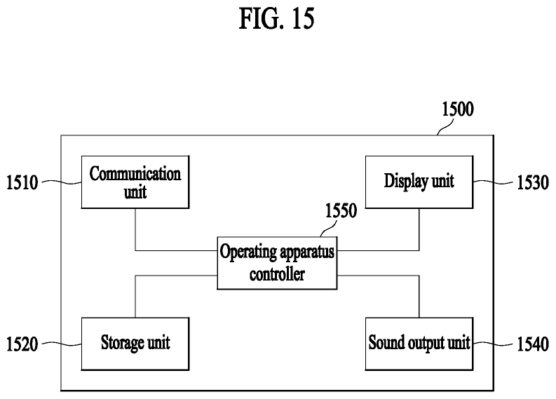

FIG. 15 is a view for explaining an operating apparatus according to an embodiment of the present disclosure.

Referring to FIG. 15, configurations included in an operating apparatus 1500 of the embodiment are disclosed.

A communication unit 1510 may perform communication with external nodes. For example, communication with operating apparatuses of other vehicles or peripheral operating apparatuses is possible, and information can be transmitted and received through vehicle to vehicle (V2V) and vehicle to everything (V2X) communication. It can also communicate with an external communication server. The communication server may be a communication server connected to the cellular network, but is not limited thereto. As such, communication unit 1510 may transmit and receive information with nodes outside operating apparatus 1500.

A storage unit 1520 may store at least one of information transmitted and received through communication unit 1510, information acquired by operating apparatus 1500, and information for controlling operating apparatus 1500. Storage unit 1520 may store algorithm information for performing the embodiment described in the embodiment. For example, an algorithm for identifying at least one of a user and an item may be stored, and an algorithm for identifying to which user the identified item belongs may be stored.

A display unit 1530 may provide the user with information visually. In the embodiment, the information related to the belongings of the user may be visually provided. It is apparent that display unit 1530 may be configured in any form that can visually provide information to the user.

A sound output unit 1540 may provide the user with information acoustically. In the embodiment, information related to the belongings of the user may be acoustically provided. It is apparent that sound output unit 1540 may be configured in any form that can acoustically provide information to the user.

An operating apparatus controller 1550 may control the overall operation of the operating apparatus in the embodiment. In addition, it can operate in the manner that the received information is checked and an additional operation is performed based on the checked information. In one example, operating apparatus controller 1550 may include at least one processor. In addition, operating apparatus controller 1550 may include a processor capable of performing deep learning, and may update an algorithm used in the embodiment.

Embodiments of the present disclosure describe a method of identifying belongings based on image information in a vehicle and providing related information to a user. It is apparent that the method of the embodiments of the present disclosure is not limited to the above, but may be applied wherever image information can be acquired in a specific region. More specifically, the embodiment of the present disclosure may be modified and applied in a form of acquiring image information in a specific building, identifying a user and belongings, and providing information about the same.

Further, identifying suspicious belongings left in the building such as airport or broadcasting station requiring a high degree of safety, as well as transportation, and providing information to the operator of the building may correspond to a variation of the embodiment of the present disclosure. More specifically, when an explosive disguised as a general belonging is left in a building, user information corresponding to the belonging may be obtained, and image information corresponding to the user's information may be provided to the manager of the building. This allows for more effective management of building safety.

Although the exemplary embodiments of the present disclosure have been described in this specification with reference to the accompanying drawings and specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of providing information from an operating apparatus, the method comprising:
acquiring a first image information on a specific space;
identifying a user based on the acquired first image information;
identifying an item based on the acquired first image information;
identifying a region corresponding to the user and a region corresponding to the item based on the acquired first image information; and
determining whether the item is a belonging of the user based on the identified region corresponding to the user and the identified region corresponding to the item.

2. The method of claim 1, wherein the determining whether the item is a belonging of the user includes determining whether the item is the belonging of the user based on whether a degree of overlapping of the region corresponding to the user and the region corresponding to the item corresponds to a first condition.

3. The method of claim 2, wherein the first condition is determined based on at least one of a type of the item and a number of users identified on the first image information.

4. The method of claim 1, wherein the determining whether the item is a belonging of the user includes:
acquiring at least one additional image information; and
determining whether the item is the belonging of the user based on whether a degree of overlapping of the region corresponding to the user and the region corresponding to the item in the at least one additional image information corresponds to a second condition.

5. The method of claim 1, further comprising:
identifying whether information on the item is provided for the user if it is determined that the item is the belonging of the user; and
providing the information on the item for the user using a first method based on a result of the identification.

6. The method of claim 5, wherein the information on the item is provided for the user if the location of the user is associated with being out of the specific space and the user and the item are spaced apart.

7. The method of claim 5, wherein the user is provided with the information on the item via an output device associated with the specific space.

8. The method of claim 5, wherein the providing the information on the item includes:
transmitting at least one of information on the space, information on the user, and information on the item to an neighboring operating apparatus, and
wherein the at least one of the information on the space, the information on the user, and the information on the item is provided for the user if the user is located in a space associated with the neighboring operating apparatus.

9. The method of claim 5, wherein the providing the information on the item includes:
identifying information of the user;
identifying a server that can communicate with a terminal of the user based on the information of the user; and
transmitting at least one of information on the space, information on the user, and information on the item to the identified server.

10. The method of claim 1, wherein the region corresponding to the item is determined based on information on the item.

11. The method of claim 1, wherein the region corresponding to the user is determined based on a number of users identified on the first image information.

12. The method of claim 1, wherein locations of the item and the user are identified in image information acquired additionally if it is determined that the item is the belonging of the user.

13. The method of claim 1, wherein the determining whether the item is a belonging of the user includes:
determining whether the item is the belonging of the user based on the region corresponding to the user and the region corresponding to the item if a region where the user is identified is adjacent to a location entering the specific space.

14. The method of claim 1, wherein the determining whether the item is a belonging of the user includes:
determining whether the item is the belonging of the user further based on information set by the user; and
wherein the information set by the user is information set via at least one of a terminal of the user and a server used by the user.

15. The method of claim 1, further comprising:
identifying belonging information set by the user; and
providing the belonging information set by the user via at least one of a terminal of the user and an output device associated with the operating apparatus if item information acquired based on the first image information does not correspond to the belonging information.

16. The method of claim 1, wherein the determining whether the item is a belonging of the user includes:
determining whether the item is the belonging of the user based on belonging information set by the user and information related to the identified item.

17. The method of claim 5, wherein the providing the information on the item includes:
providing the information on the item for the user using a second method if the item is an item capable of providing the user with information.

18. The method of claim 1, further comprising:
acquiring second image information; and
if an item identified as a belonging to the user is carried by another user based on the second image information, providing related information for the user.

19. An operating apparatus comprising:
a communication unit configured to receive information; and
a controller configured to control the communication unit, acquire a first image information on a specific space, identify a user based on the acquired first image information, identify an item based on the acquired first image information, identify a region corresponding to the user and a region corresponding to the item based on the acquired first image information, and determine whether the item is a belonging of the user based on the identified region corresponding to the user and the identified region corresponding to the item.

20. A non-volatile storage medium that stores an instruction for executing the method of any one of claim 1.
